(19) United States
(12) Patent Application Publication
(10) Pub. No.: US 2006/0029808 A1
(43) Pub. Date: Feb. 9, 2006

(54) Superhydrophobic coatings

(76) Inventors: Lei Zhai, Somerville, MA (US); Fevzi C. Cebeci, Istanbul (TR); Robert E. Cohen, Jamaica Plain, MA (US); Michael F. Rubner, Westford, MA (US)

Correspondence Address: STEPTOE & JOHNSON LLP, 1330 CONNECTICUT AVENUE, N.W., WASHINGTON, DC, 20036, US

(21) Appl. No.: 10/912,576

(22) Filed: Aug. 6, 2004

(51) Int. Cl. B05D 3/02; B05D 1/36; B32B 27/36; B32B 17/06; B32B 9/04

(52) U.S. Cl. 428/412; 427/402; 427/372.2; 428/426; 428/447

(57) ABSTRACT

A superhydrophobic coating can have a water contact angle greater than 150°. The coating can remain superhydrophobic after being immersed in water for one week.

### FEDERALLY SPONSORED RESEARCH OR DEVELOPMENT

The U.S. Government may have certain rights in this invention pursuant to Grant Nos. CTS-9729569 and DMR-9808941 awarded by the National Science Foundation.

### TECHNICAL FIELD

This invention relates to superhydrophobic coatings.

### BACKGROUND

Many plants in nature, including the lotus leaf, exhibit the unusual wetting characteristic of superhydrophobicity. A superhydrophobic surface is one that can cause water droplets to bead off completely. Such surfaces exhibit water droplet advancing contact angles of 150° or higher. In addition, the contact angle hysteresis can be very low (the receding contact angle is within 5° of the advancing contact angle), producing a surface on which water droplets simply roll off. A self-cleaning surface results since the rolling water droplets remove dirt and debris. The lotus leaf accomplishes this effect through the use of a surface topography that presents two different length scales to the outside environment. The surface of the lotus leaf, for example, is textured with 3-10 micron-sized hills and valleys that are decorated with nanometer-size particles of a hydrophobic wax-like material. The hills and valleys insure that the surface contact area available to water is very low while the hydrophobic nanoparticles prevent penetration of water into the valleys. The net result is that water cannot wet the surface and therefore forms nearly spherical water droplets, leading to superhydrophobic surfaces.

### SUMMARY

Synthetic superhydrophobic surfaces have been fabricated through various approaches. A superhydrophobic surface is a surface that has a water droplet advancing contact angle of 150° or higher and the receding contact angle is within 5° of the advancing contact angle. Previous methods of fabricating superhydrophobic coatings can be expensive, substrate limited, require the use of harsh chemical treatments, or cannot be easily scaled-up to create large-area uniform coatings. Consequently, many of these methods are not readily suitable for the coating of the surfaces of complex substrates like the channels of a microfluidic device, fiber surfaces, or intricate shapes, such as, for example, found on a stent.

Superhydrophobic coatings can be prepared from polyelectrolyte multilayers. The coatings can be formed conformally on complicated surfaces. A wide variety of materials can be coated such as glass, plastic, metal or fibers. The coatings can remain superhydrophobic following prolonged exposure to water (e.g., after continuous exposure to water for up to one week). The same techniques can be used to make superhydrophilic coatings. A surface can be patterned with superhydrophilic and superhydrophobic regions.

In one aspect, a superhydrophobic surface includes a high roughness polyelectrolyte multilayer arranged on a substrate, a plurality of nanometer-scale features associated with the high roughness polyelectrolyte multilayer, and a hydrophobic coating over the substrate.

In another aspect, a superhydrophobic surface includes a polyelectrolyte multilayer arranged on a substrate, where the surface has an advancing water contact angle of greater than 150°, and the advancing water contact angle differs from the receding water contact by less than 5°.

In another aspect, a superhydrophobic surface includes a high roughness polyelectrolyte multilayer arranged on a substrate, a plurality of nanometer-scale features associated with the high roughness polyelectrolyte multilayer, and a hydrophobic coating over the substrate, where the surface has an advancing water contact angle of greater than 150° and a receding water contact angle, and the advancing water contact angle differs from the receding water contact by less than 5°.

The nanometer-scale features can include a nanoparticle. The polyelectrolyte multilayer can include poly(allylamine hydrochloride) or poly(acrylic acid). The high roughness polyelectrolyte multilayer can be a porous polyelectrolyte multilayer. The polyelectrolyte multilayer can include a pore between 0.2 micrometers and 20 micrometers in size. The plurality of nanometer-scale features can include a nanoparticle between 1 nanometer and 100 nanometers in size. The plurality of nanometer-scale features can include a silica nanoparticle, a silver nanoparticle, a gold nanoparticle, or a polystyrene nanoparticle.

The surface can have an advancing water contact angle of greater than 150°. The surface can have a receding water contact angle of greater than 150°. The advancing water contact angle and the receding water contact angle can differ by no more than 5°. The surface can remain superhydrophobic after a one-week immersion in water.

The hydrophobic coating can include a hydrophobic silane. The hydrophobic coating can include a fluoropolymer. The substrate can be glass or plastic.

In another aspect, a superhydrophilic surface includes a polyelectrolyte multilayer arranged on a substrate. The polyelectrolyte multilayer can be a porous polyelectrolyte multilayer. The polyelectrolyte multilayer can include poly(allylamine hydrochloride) or poly(acrylic acid). The polyelectrolyte multilayer can include a pore between 0.2 micrometers and 20 micrometers in size. The superhydrophilic surface can include a plurality of nanometer-scale features associated with the polyelectrolyte multilayer. The plurality of nanometer-scale features can include a nanoparticle between 1 nanometer and 100 nanometers in size. The superhydrophilic surface can have a water contact angle of less than 5°.

In another aspect, a surface includes a polyelectrolyte multilayer arranged on a substrate, where the surface includes a superhydrophobic region and a superhydrophilic region. The superhydrophobic region or the superhydrophilic region can form a pattern on the surface.

In another aspect, a method of making a superhydrophobic surface includes coating a superhydrophilic surface with a hydrophobic material.

In another aspect, a method of altering the wettability of a surface includes providing a substrate having a surface coated with a coating including a polyelectrolyte, contacting the coating including the polyelectrolyte with a micropore-forming medium to form micropores in the coating, and introducing a plurality of nanometer-scale features associated with the coating to form a composite coating.

The method can include forming a hydrophobic coating over the composite coating. Introducing a plurality of nanometer-scale features can include contacting the coating with a plurality of nanoparticles. Providing the substrate can include contacting the substrate with a polyelectrolyte. The polyelectrolyte can be a component of an aqueous solution. The aqueous solution can include poly(allylamine hydrochloride) or poly(acrylic acid). The micropore-forming medium can be an aqueous medium. The method can include crosslinking the coating including the polyelectrolyte. Crosslinking the coating can include heating the coating. Forming a hydrophobic coating over the composite coating can include contacting the composite coating with a hydrophobic silane or with a fluoropolymer.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1A and 1B are scanning electron microscope images of porous polyelectrolyte multilayers.

FIG. 2 is a graph depicting water contact angles for different surfaces.

FIG. 3A is a scanning electron microscope image of a superhydrophobic surface. FIG. 3B is a photograph of a water droplet on the superhydrophobic surface.

FIGS. 4A and 4B are graphs depicting X-ray photoelectron spectroscopy measurements of surfaces.

### DETAILED DESCRIPTION

A hydrophobic surface repels water. In general, a non-hydrophobic surface can be made hydrophobic by coating the surface with a hydrophobic material. The hydrophobicity of a surface can be measured, for example, by determining the contact angle of a drop of water on the surface. The contact angle can be a static contact angle or dynamic contact angles. A dynamic contact angle measurement can include determining an advancing contact angle or a receding contact angle, or both. A hydrophobic surface having a small difference between advancing and receding contact angles (i.e., low contact angle hysteresis) can be desirable. Water can travel across a surface having low contact angle hysteresis more readily than across a surface having a high contact angle hysteresis.

A surface can be superhydrophobic, i.e. exhibiting water droplet advancing contact angles of 150° or higher. The lotus leaf provides an example of a superhydrophobic surface (See Neinhuis, C.; Barthlott, W. Ann. Bot. 1997, 79, 677; and Barthlott, W.; Neinhuis, C. Planta 1997, 202, 1, each of which is incorporated by reference in its entirety). The lotus leaf also exhibits very low contact angle hysteresis: the receding contact angle is within 5° of the advancing contact angle (See, for example, Chen, W.; et al. Langmuir 1999, 15, 3395; and Oner, D.; McCarthy, T. J. Langmuir 2000, 16, 7777, each of which is incorporated by reference in its entirety).

Increasing the roughness of a hydrophobic surface can dramatically increase its hydrophobicity. Two distinct wetting behaviors are possible, depending upon the nature and extent of the surface roughness. In one roughness regime, called the Wenzel state, water is able to penetrate into the surface cavities, and water droplets become pinned to the surface and remain pinned even when the surface is tilted to a high angle. In contrast, the Cassie state refers to a roughness regime in which water does not penetrate into the surface cavities. In this state, water droplets sit partially on surface air pockets and slide or roll easily when the surface is tilted even a only few degrees. In both roughness regimes, surfaces can have advancing water droplet contact angles in excess of 150°. Only in the Cassie state, however, does the surface also exhibit a low contact angle hysteresis (See, for example, Wenzel, R. N. Ind. Eng. Chem. 1936, 28, 988; Wenzel, R. N. J. Phys. Colloid Chem. 1949, 53, 1466; and Cassie, A. B. D.; Baxter, S. Trans. Faraday Soc. 1944, 40, 546, each of which is incorporated by reference in its entirety).

The water contact angle for a hypothetical sinusoidal hydrophobic surfaces with various roughness can be calculated (see, for example, Johnson, R. E.; Dettre, R. H. Adv. Chem. Ser. 1963, 43, 112, which is incorporated by reference in its entirety). When the Wenzel mode is dominant, both the contact angle and contact angle hysteresis increase as the surface roughness increases. When a roughness factor exceeds a critical level, however, the contact angle continues to increase while the hysteresis starts decreasing. At this point, the dominant wetting behavior changes, due to an increase the amount of air trapped at the interface between the surface and water droplet. Thus, if stable, low hysteresis, superhydrophobic surfaces are desired, it is necessary to create the critical level of surface roughness needed to establish the Cassie state.

Synthetic superhydrophobic surfaces have been made by creating a rough surface covered with low surface energy molecules (see, for example, Lau, K. K. S. et al., Nano Lett. 2003, 3, 1701; Feng, L. et al., Adv. Mater. 2002, 14, 1857; Feng, L. et al., Angew. Chem. Int. Ed. 2003, 42, 800; Feng, L. et al., Angew. Chem. Int. Ed. 2002, 41, 1221; Li, H.; Wang, et al., Angew. Chem. Int. Ed. 2001, 40, 1743; Thieme, M. et al., Adv. Eng. Mater. 2001, 3, 691; Youngblood, J. P. and McCarthy, T. J. Macromolecules 1999, 32,6800; and Tadanaga, K., et al., Chem. Mater. 2000, 12, 590, each of which is incorporated by reference in its entirety). Other methods of preparing synthetic superhydrophobic surfaces include roughening the surface of hydrophobic materials (see, for example, Morra, M., et al., Langmuir 1989, 5, 872; Morra, M., et al., Colloid Inerface Sci. 1989, 132, 504; and Erbil, H. Y., et al., Science 2003, 299, 1377, each of which is incorporated by reference in its entirety) and by generating well-ordered microstructured surfaces with a small ratio of the liquid-solid contact area (see, for example, Chen, W., et al., Langmuir 1999, 15, 3395; Oner, D. and McCarthy, T. J. Langmuir 2000, 16, 7777; and Shiu, J.-Y., et al., Chem. Mater. 2004, 16, 561, each of which is incorporated by reference in its entirety).

A superhydrophobic surface can be fabricated from a polyelectrolyte coating. A polyelectrolyte has a backbone with a plurality of charged functional groups attached to the backbone. A polyelectrolyte can be polycationic or polyanionic. A polycation has a backbone with a plurality of positively charged functional groups attached to the backbone, for example poly(allylamine hydrochloride). A polyanion has a backbone with a plurality of negatively charged functional groups attached to the backbone, such as sulfonated polystyrene (SPS) or poly(acrylic acid), or a salt thereof. Some polyelectrolytes can lose their charge (i.e., become electrically neutral) depending on conditions such as pH. Some polyelectrolytes, such as copolymers, can include both polycationic segments and polyanionic segments.

Layer-by-layer processing of polyelectrolyte multilayers can be utilized to fabricate conformal thin film coatings with molecular level control over film thickness and chemistry. Charged polyelectrolytes can be assembled in a layer-by-layer fashion. In other words, positively- and negatively-charged polyelectrolytes can be alternately deposited on a substrate. One method of depositing the polyelectrolytes is to contact the substrate with an aqueous solution of polyelectrolyte at an appropriate pH. The pH can be chosen such that the polyelectrolyte is partially or weakly charged. The multilayer can be described by the number of bilayers it includes, a bilayer being the structure formed by the ordered application of oppositely charged polyelectrolytes. For example, a multilayer having the structure PAH-PAA-PAH-PAA-PAH-PAA would be said to be made of three bilayers.

These methods can provide a new level of molecular control over the deposition process by simply adjusting the pH of the processing solutions. A nonporous polyelectrolyte multilayers can form porous thin film structures induced by a simple acidic, aqueous process. Tuning of this pore forming process, for example, by the manipulation of such parameters as salt content (ionic strength), temperature, or surfactant chemistry, can lead to the creation of micropores, nanopores, or a combination thereof. A nanopore has a diameter of less than 150 nm, for example, between 1 and 120 nm or between 10 and 100 nm. A nanopore can have diameters of less than 100 nm. A micropore has a diameter of greater than 150 nm, typically greater than 200 nm. Selection of pore forming conditions can provide control over the porosity of the coating. For example, the coating can be a nanoporous coating, substantially free of micropores. Alternatively, the coating can be a microporous coating having an average pore diameters of greater than 200 nm, such as 250 nm, 500 nm, 1 micron, 2 microns, 5 microns, 10 microns, or larger.

The properties of weakly charged polyelectrolytes can be precisely controlled by changes in pH. See, for example, G. Decher, Science 1997, 277, 1232; Mendelsohn et al., Langmuir 2000, 16, 5017; Fery et al., Langmuir 2001, 17, 3779; Shiratori et al., Macromolecules 2000, 33, 4213; and U.S. patent application Ser. No. 10/393,360, each of which is incorporated by reference in its entirety. A coating of this type can be applied to any surface amenable to the water based layer-by-layer (LbL) adsorption process used to construct these polyelectrolyte multilayers. Because the water based process can deposit polyelectrolytes wherever the aqueous solution contacts a surface, even the inside surfaces of objects having a complex topology can be coated. In general, a polyelectrolyte can be applied to a surface by any method amenable to applying an aqueous solution to a surface, such as dipping or spraying.

Superhydrophobic surfaces can be created from multilayer films. Such conformable superhydrophobic surfaces can have applications as antifouling, self-cleaning and water resistant coatings, as an anti-cell adhesion (e.g., antibacterial) coating, as an electrical or thermal insulating coating, as a flow-increasing coating (e.g., on the interior wall of a pipe) and as coatings for microfluidic channels and biosensors.

Polyelectrolyte multilayer films have been used as a template to provide the surface roughness of a superhydrophobic surface. A layer-by-layer process was used to assemble a polyelectrolyte multilayer containing SiO₂ nanoparticles. The film was then heated to 650° C. to remove the polyelectrolytes and create the surface texture needed for superhydrophobic behavior (see Soeno, T. et al. Transactions of the Materials Research Society of Japan 2003, 28, 1207, which is incorporated by reference in its entirety). In another example, dendritic gold clusters were electrochemically deposited onto indium tin oxide (ITO) electrodes covered with a polyelectrolyte multilayer film. After the deposition of a n-dodecanethiol monolayer on the gold clusters, the surface showed superhydrophobic behavior (see Zhang, X. et al. J. Am. Chem. Soc. 2004, 126, 3064, which is incorporated by reference in its entirety). The electrochemical deposition process used to create these films can limit the types of materials that this method can be used to form a superhydrophobic coating on.

A superhydrophobic surface can include a polyelectrolyte multilayer. A surface can be coated with the multilayer using a layer-by-layer method. Treatment of the multilayer can induce the formation of roughness in the multilayer. The multilayer can become a high roughness multilayer. High roughness can be micrometer scale roughness. The high roughness surface can have an rms roughness of 100 nm, 150 nm, 200 nm, or greater. Treatments that induce the formation of high roughness can include an acid treatment or a salt treatment (i.e., treatment with an aqueous solution of a salt). Formation of pores in the polyelectrolyte multilayer can lead to the development of high roughness in the multilayer. Appropriate selection of conditions (e.g., pH, temperature, processing time) can promote formation of pores of different sizes. The pores can be micropores (e.g., pores with diameters at the micrometer scale, such as greater than 200 nm, greater than 500 nm, greater than 1 micrometer, or 10 micrometers or later). A microporous polyelectrolyte multilayer can be a high roughness polyelectrolyte multilayer.

A high roughness polyelectrolyte multilayer can be formed by forming the polyelectrolyte multilayer over a high roughness surface. When the polyelectrolyte multilayer is formed over a high roughness surface, a treatment to increase the polyelectrolyte multilayer of the polyelectrolyte multilayer can be optional. The high roughness surface can include, for example, micrometer scale particles, such as nanospheres, microspheres, or an area of elevations, ridges or depressions. The micrometer scale particles can be, for example, particles of a clay or other particulate material. Elevations, ridges or depressions can be formed, for example, by etching, depositing micrometer scale particles, or photolithography on a suitable substrate.

A lock-in step can prevent further changes in the structure of the porous multilayer. The lock-in can be achieved by, for example, exposure of the multilayer to chemical or thermal polymerization conditions. The polyelectrolytes can become cross-linked and unable to undergo further transitions in porosity. In some cases, chemical crosslinking step can include treatment of a polyelectrolyte multilayer with a carbodiimide reagent. The carbodiimide can promote the formation of crosslinks between carboxylate and amine groups of the polyelectrolytes. A chemical crosslinking step can be preferred when the polyelectrolyte multilayer is formed on a substrate that is unstable at temperatures required for crosslinking (such as, for example, when the substrate is polystyrene). The crosslinking step can be a photocrosslinking step. The photocrosslinking can use a sensitizer (e.g., a light-sensitive group) and exposure to light (such as UV, visible or IR light) to achieve crosslinking. Masks can be used to form a pattern of crosslinked and non-crosslinked regions on a surface. Other methods for crosslinking polymer chains of the polyelectrolyte multilayer are known.

Nanoparticles can be applied to the multilayer, to provide a nanometer-scale texture or roughness to the surface. The nanoparticles can be nanospheres such as, for example, silica nanospheres, titania nanospheres, polymer nanospheres (such as polystyrene nanospheres), or metallic nanospheres. The nanoparticles can be metallic nanoparticles, such as gold or silver nanoparticles. The nanoparticles can have diameters of, for example, between 1 and 1000 nanometers, between 10 and 500 nanometers, between 20 and 100 nanometers, or between 1 and 100 nanometers.

A surface can be coated with a hydrophobic material. In general, any hydrophobic material that can be applied over the surface can be used. A material that reacts chemically or physically with a polyelectrolyte multilayer can be used. The hydrophobic material can be chemically bonded to the multilayer, to the nanoparticles, or to both. The hydrophobic material can be a polymeric material, such as a poly(tetrafluoroethylene) or a hydrophobic polysiloxane. The polymeric material can be a fluoropolymer, or a fluorosilane. The hydrophobic material can be applied to the surface by a vapor deposition process, e.g., chemical vapor deposition (CVD) or hot filament chemical vapor deposition (HFCVD). See, for example, Lau, K. K. S. et al., Nano Lett. 2003, 3, 1701, which is incorporated by reference in its entirety.

### EXAMPLES

Multilayers assembled from poly(allylamine hydrochloride) (PAH) and poly(acrylic acid) (PAA) with the PAH dipping solution at a pH of 7.5 or 8.5 and the PAA dipping solution at a pH of 3.5 (designated PAH/PAA 7.5/3.5 or 8.5/3.5) formed microporous structures when treated at pH 2.4 followed by a deionized water rinse. See, for example, Mendelsohn, J. D. et al. Langmuir 2000, 16, 5017; and Hiller, J. et al. Nature Materials 2002, 11, 59, each of which is incorporated by reference in its entirety. The surface roughness of these films after treatment was below 100 nm, too low to promote stable superhydrophobic behavior. By using an appropriate combination of acidic treatments, PAH/PAA 8.5/3.5 films were induced to form pores of a size on the order of 10 micrometers and a honeycomb-like structure on the surface. The surface roughness of such films can be more than 400 nm, making them ideally suited for use as the high roughness template of a superhydrophobic surface. It can be preferable not to rinse the film with water after low pH treatment. A staged low pH treatment can be preferable to a single low pH treatment.

PAH (M_{w}=70,000) was obtained from Sigma-Aldrich (St. Louis, Mo.). PAA (M_{w}=90,000) and silica nanoparticles were obtained from Polysciences (Warrington, Pa.). (Tridecafluoro-1,1,2,2-tetrahydrooctyl)-1-trichlorosilane was obtained from United Chemical Technology, Inc. Deionized water (>18 MΩ cm, Millipore Milli-Q), with an unadjusted pH of approximately 5.5, was exclusively used in all aqueous solutions and rinsing procedures.

Polyelectrolyte multilayers were assembled on glass microscope slides or 3-aminopropyltriethoxysilane coated microscope slides (LabScientific, Inc.) using an automated Zeiss HMS slide stainer as previously described. (See, for example, Shiratori, S. S.; Rubner, M. F. Macromolecules 2000, 33, 4213.) Glass substrates were degreased in a detergent solution followed by deionized water rinses prior to multilayer assembly. Silane coated microscope slides were used as received.

PAH/PAA multilayer films were built using pH 8.5 PAH (10⁻² M by repeat unit) and pH 3.5 PAA (10⁻² M) aqueous solutions which were pH adjusted by using either 1 M NaOH or 1 M HCl. The first four PAH/PAA bilayers on glass slides were formed by first immersing substrates into the PAH solution for 15 minutes followed by one 2 minute and two 1 minute immersions into water as rinsing steps. Then, the substrates were immersed into the PAA solution for 15 min followed by identical rinsing steps. The rest of the PEM layers were assembled by immersion into the polyelectrolyte solutions for 30 seconds followed by one 1 minute and two 30 second immersions into water as rinsing steps. The adsorption and rinsing steps were repeated until the desired numbers of bilayers were obtained. One bilayer is defined as a single adsorption of a polycation followed by an adsorption of a polyanion; thus a half-integer number of bilayers of PAH/PAA ends with PAH as the outermost layer. A low pH treatment (for example, at a pH of less than pH 5, less than pH 4, between pH 0 and pH 4, or between pH 2 and pH 3) of the polyelectrolyte multilayer introduced pores in the multilayer. The low pH treatment can be a one step treatment or a multistep treatment. For example, a two step treatment can include treatment of the multilayer a pH 2.7 solution and a pH 2.3 solution. The polyelectrolyte multilayers were crosslinked by a 2 hour heat treatment at 180° C.

1.5 bilayers of silica nanoparticles/PAH were deposited on the crosslinked porous multilayer films using a 0.06% aqueous colloidal dispersion of silica nanoparticles and pH 8.5 PAH (10⁻² M by repeat unit) by first immersing the film into the silica nanoparticle suspension for 5 minutes followed by one 1 minute and two 30 second immersions into water as rinsing steps. Then, the film was immersed into the PAH solution for 5 minutes followed by identical rinsing steps. The film was immersed in the silica nanoparticle solution again for 5 minutes followed by one 1 minute and two 30 second immersions into water as rinsing steps.

The silane treatment was carried out by a chemical vapor deposition of (tridecafluoro-1,1,2,2-tetrahydrooctyl)-1-trichlorosilane. Samples were placed in a vacuum chamber together with (tridecafluoro-1,1,2,2-tetrahydrooctyl)-1-trichlorosilane. CVD was performed by applying a 1 Torr vacuum to the chamber at room temperature for 2 hours. Then, the samples were placed in an oven and heated at 180° C. for 2 hours.

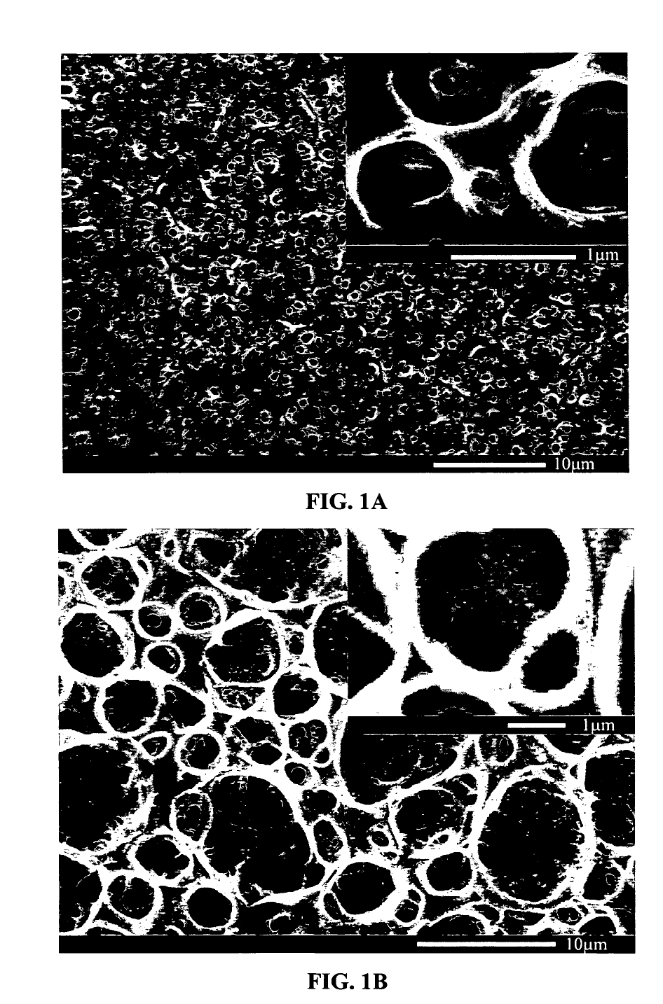

FIG. 1A shows a scanning electron microscope (SEM) image of a porous PAH/PAA 8.5/3.5 film containing 100.5 assembled bilayers that was created by a single low pH treatment (6 hour immersion in a pH 2.3 solution, with no water rinse). The resultant film exhibits surface pores on the order of 0.5-2 microns and an RMS surface roughness of about 100 nm. In contrast, a 100.5 bilayer PAH/PAA 8.5/3.5 porous film created by a combination of two low pH treatments (i.e., a 2 hour immersion in a pH 2.7 solution followed by a 4 hour immersion in a pH 2.3 solution, with no water rinse) had a surface roughness of about 440 nm (FIG. 1B). This film exhibits a honeycomb-like texture with sharp ridges and surface pores as large as 10 micrometers. The surface roughness decreased dramatically when a water rinse (pH about 5.5) followed these low pH treatments.

The two porous PAH/PAA 8.5/3.5 films with micrometer-scale surface roughness were used as templates for nanoparticle deposition. Both structures were first thermally crosslinked at 180° C. for two hours to preserve desirable surface morphological features throughout the subsequent processing steps (see Dai, J. et al. Langmuir 2001, 17, 931, which is incorporated by reference in its entirety). Nanoscale texture was introduced by depositing 50 nm SiO₂ nanoparticles onto the surfaces via alternating dipping of the substrates into an aqueous suspension of the negatively charged nanoparticles and an aqueous PAH solution followed by a final dipping of the substrates into the nanoparticle suspension. The surfaces were then modified by a chemical vapor deposition (CVD) of (tridecafluoro-1,1,2,2-tetrahydrooctyl)-1-trichlorosilane (semifluorinated silane) followed by a 2 hour heating at 180° C. to remove unreacted semifluorinated silane. These final steps rendered the entire surface hydrophobic.

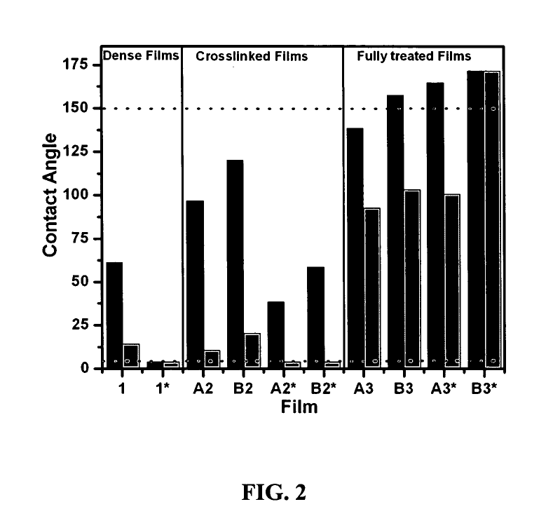

Dynamic contact angle measurements were carried out on the two types of structures depicted in FIG. 1 after each treatment step to reveal the relationship between contact angle and surface morphology and chemistry. FIG. 2 shows the dynamic contact angles measured from structure A (i.e., the structure depicted in FIG. 1A) and structure B (i.e., the structure depicted in FIG. 1B) at various stages of the process. Both advancing (black bars) and receding (grey bars) contact angles were measured from as-assembled dense films, crosslinked microporous films, and fully treated microporous films, each with and without the surface bound SiO₂ nanoparticles (structures with SiO₂ nanoparticles are indicated by *). At each treatment step, the advancing contact angle measured from structure B was larger than that measured from structure A, consistent with the predictions of both the Wenzel and Cassie models (for a given chemical composition, rougher surfaces exhibit larger advancing contact angles). The deposition of hydrophilic silica nanoparticles onto the surfaces of both crosslinked structures caused the advancing contact angle to decrease, since the surfaces were covered with more wettable hydrophilic groups. After the deposition of the semifluorinated silane and heating, all surfaces changed from hydrophilic to hydrophobic with large advancing contact angles (>120°).

Among the surfaces coated with semifluorinated silane, superhydrophobic character (advancing contact angle >150°) was observed from all surfaces except structure A without nanoparticles. A low contact angle hysteresis was exhibited by structure B coated with nanoparticles. In this case, water droplets freely rolled off the surface without becoming pinned even after sitting on the surface for long times. In contrast, water droplets on the surfaces of structure A coated with nanoparticles and on the surface of structure B without nanoparticles started to become pinned after sitting on the surface for a couple of minutes, suggesting a transition from the Cassie state to the Wenzel state. Both the microstructure created by the combined acid treatments and the nanostructure induced by the deposition of nanoparticles can be important for the formation of stable superhydrophobic surfaces.

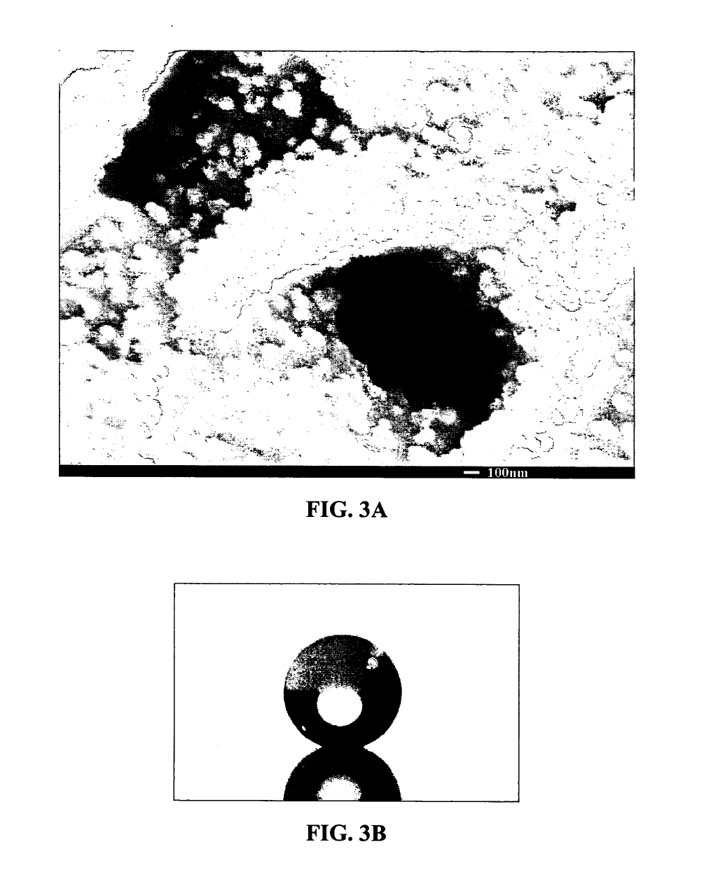

FIG. 3A shows a high resolution SEM image of the final superhydrophobic surface fabricated from structure B. The nanoparticles decorated the surface of the micropores, forming a two-level structure that conceptually mimics the lotus leaf surface. FIG. 3B shows a water droplet on this surface, having an advancing contact angle of 172°. The lowest angle needed to induce sliding of a 4 mg water droplet on this surface was less than 2°, which suggests a very small contact angle hysteresis with essentially no pinning of the water droplet. This surface remained superhydrophobic after being immersed in water for at least a week, or after being stored in a high humidity environment for at least a month. This stands in contrast to the superhydrophobic surface created from structure A (A3* in FIG. 2), which lost its superhydrophobic character after a brief immersion in water.

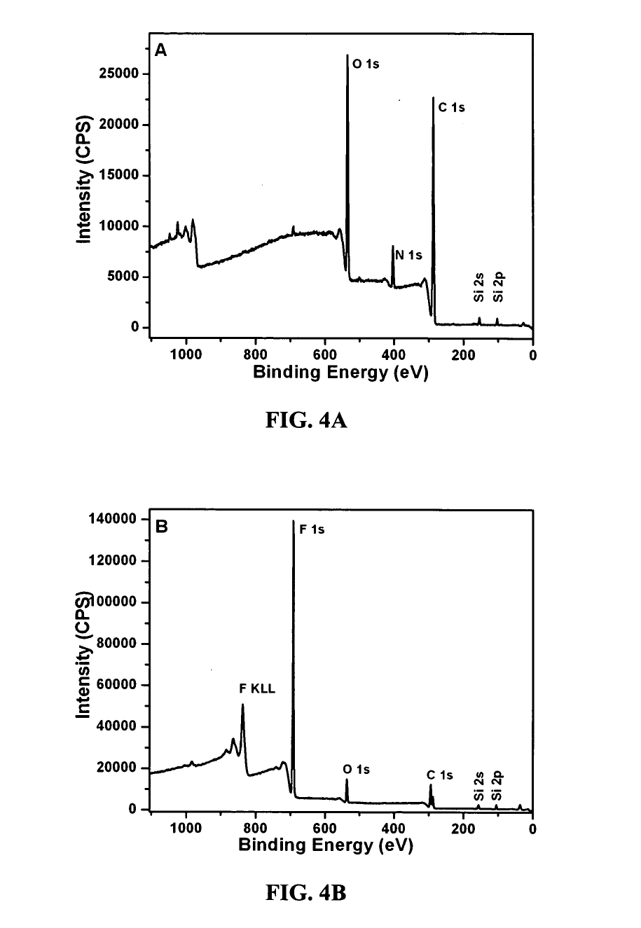

X-ray photoelectron spectroscopy (XPS) confirmed that the superhydrophobic surface of structure B was modified with the semifluorinated silane (FIG. 4). The XPS spectrum of the crosslinked porous multilayer film with silica nanoparticles showed no detectable fluorine peaks (FIG. 4A), whereas the spectrum of the semifluorinated silane coated film displayed a strong fluorine peak at 688 eV (FIG. 4B). This strong fluorine peak suggests the formation of a polymerized silane film on the surface that is thicker than a single monolayer. The silicon peaks located at 156 eV and 103 eV in FIG. 4A are attributed to the silica nanoparticles deposited on the surface of the crosslinked multilayer film. After the CVD of (tridecafluoro-1,1,2,2-tetrahydrooctyl)-1-trichlorosilane and the subsequent thermal treatment, the intensity of these peaks increased due to the formation of the polymerized silane film (FIG. 4B). In addition to reacting with the silica nanoparticles, the semifluorinated silane can also react with free amine groups on the surface of the crosslinked multilayer film. This was confirmed by examining the XPS spectrum of a porous crosslinked film without nanoparticles after CVD and thermal treatment: a strong fluorine peak located at 688 eV was also observed in this case.

A straight-forward procedure can create stable superhydrophobic coatings from polyelectrolyte multilayers. It is possible to coat any substrate or object amenable to the layer-by-layer deposition process, which is essentially all surfaces. Superhydrophobic coatings can be prepared from PAH/PAA multilayers with as few as 20 bilayers and with shorter treatment and crosslinking times.

A 20.5 bilayer PAH/PAA (7.5/3.5) film was immersed in a pH 2.7 solution for 20 minutes and a pH 2.3 solution for 40 minutes. The film was then dried with air and crosslinked at 180° C. for 2 hours. An additional 3.5 bilayers of PAH/silica nanoparticles were deposited on the surface, followed by CVD of semifluorinated silane. After a 2 hour heat treatment at 180° C., the surface was superhydrophobic.

Superhydrophobic coatings were successfully made on fibers.

Semifluorinated silane was deposited on acid treated films bearing silica nanoparticles by immersing the samples into 0.4% (v/v) isopropanol solution of (tridecafluoro-1,1,2,2-tetrahydrooctyl)-1-trichlorosilane for 5 seconds, or by spin coating a 2% (v/v) isopropanol solution of (tridecafluoro-1,1,2,2-tetrahydrooctyl)-1-trichlorosilane. Superhydrophobic surfaces were obtained after heating the films at 130° C. for 10 minutes.

A superhydrophobic surface was patterned with hydrophilic regions by printing 0.25% (w/v) isopropanol solutions of poly(acrylic acid) on the superhydrophobic surfaces using an Epson inkjet print or a cotton swab. This can also be achieved by using a 2% (w/w) isopropanol solution of titanium (IV) isopropoxide.

The multilayers can be superhydrophilic prior to coating with a hydrophobic material. The superhydrophilic behavior is characterized by nearly instantaneous wetting by water, and advancing and receding contact angles differ by less than 5°. Thus, this approach can create both superhydrophobic and superhydrophilic coatings with identical surface morphologies but with dramatically different wetting characteristics. A surface can include both superhydrophobic and superhydrophilic regions. The superhydrophobic and superhydrophilic regions can form a pattern on the surface. Such a patterned surface could be useful, for example, in a microfluidic device.

The superhydrophobic surface can trap a layer of air at the superhydrophobic surface when submerged under water. Because of the difference in refractive indices between water and air, this air layer can act as a mirror.

Other embodiments are within the scope of the following claims.

What is claimed is:

1. A superhydrophobic surface comprising:
a high roughness polyelectrolyte multilayer arranged on a substrate;
a plurality of nanometer-scale features associated with the high roughness polyelectrolyte multilayer; and
a hydrophobic coating over the substrate.

2. The surface of claim 1, wherein the nanometer-scale features include a nanoparticle.

3. The surface of claim 1, wherein the high roughness polyelectrolyte multilayer includes poly(allylamine hydrochloride).

4. The surface of claim 1, wherein the high roughness polyelectrolyte multilayer includes poly(acrylic acid).

5. The surface of claim 1, wherein the high roughness polyelectrolyte multilayer is a porous polyelectrolyte multilayer.

6. The surface of claim 5, wherein the polyelectrolyte multilayer includes a pore between 0.2 micrometers and 20 micrometers in size.

7. The surface of claim 1, wherein the plurality of nanometer-scale features includes a nanoparticle between 1 nanometer and 100 nanometers in size.

8. The surface of claim 1, wherein the plurality of nanometer-scale features includes a silica nanoparticle, a silver nanoparticle, a gold nanoparticle, or a polystyrene nanoparticle.

9. The surface of claim 1, wherein the surface has an advancing water contact angle of greater than 150°.

10. The surface of claim 9, wherein the surface has a receding water contact angle of greater than 150°.

11. The surface of claim 1, wherein the surface has an advancing water contact angle and a receding water contact angle that differ by no more than 5°.

12. The surface of claim 1, wherein the surface remains superhydrophobic after a one-week immersion in water.

13. The surface of claim 1, wherein the hydrophobic coating includes a hydrophobic silane.

14. The surface of claim 1, wherein the hydrophobic coating includes a fluoropolymer.

15. The surface of claim 1, wherein the substrate is glass.

16. The surface of claim 1, wherein the substrate is plastic.

17. A superhydrophobic surface comprising a polyelectrolyte multilayer arranged on a substrate, wherein the surface has an advancing water contact angle of greater than 150° and a receding water contact angle, and the advancing water contact angle differs from the receding water contact by less than 5°.

18. The surface of claim 17, wherein the polyelectrolyte multilayer is a high roughness polyelectrolyte multilayer.

19. The surface of claim 17, wherein the polyelectrolyte multilayer includes poly(allylamine hydrochloride).

20. The surface of claim 17, wherein the polyelectrolyte multilayer includes poly(acrylic acid).

21. The surface of claim 20, wherein the polyelectrolyte multilayer is a porous polyelectrolyte multilayer.

22. The surface of claim 21, wherein the polyelectrolyte multilayer includes a pore between 0.2 micrometers and 20 micrometers in size.

23. The surface of claim 17, further comprising a plurality of nanometer-scale features associated with the polyelectrolyte multilayer.

24. The surface of claim 23, wherein in the plurality of nanometer-scale features includes a nanoparticle between 1 nanometer and 100 nanometers in size.

25. The surface of claim 17, further comprising a hydrophobic coating over the substrate.

26. The surface of claim 25, wherein the hydrophobic coating includes a hydrophobic silane.

27. The surface of claim 25, wherein the hydrophobic coating includes a fluoropolymer.

28. The surface of claim 17, wherein the surface remains superhydrophobic after a one-week immersion in water.

29. The surface of claim 17, wherein the substrate is glass.

30. The surface of claim 17, wherein the substrate is plastic.

31. A superhydrophobic surface comprising:
a high roughness polyelectrolyte multilayer arranged on a substrate;
a plurality of nanometer-scale features associated with the high roughness polyelectrolyte multilayer; and
a hydrophobic coating over the substrate;
wherein the surface has an advancing water contact angle of greater than 150° and a receding water contact angle, and the advancing water contact angle differs from the receding water contact by less than 5°.

32. The surface of claim 31, wherein the surface remains superhydrophobic after a one-week immersion in water.

33. A superhydrophilic surface comprising a polyelectrolyte multilayer arranged on a substrate.

34. The surface of claim 33, wherein the polyelectrolyte multilayer is a porous polyelectrolyte multilayer.

35. The surface of claim 33, wherein the polyelectrolyte multilayer includes a pore between 0.2 micrometers and 20 micrometers in size.

36. The surface of claim 33, wherein the polyelectrolyte multilayer includes poly(allylamine hydrochloride).

37. The surface of claim 33, wherein the polyelectrolyte multilayer includes poly(acrylic acid).

38. The surface of claim 33, further comprising a plurality of nanometer-scale features associated with the polyelectrolyte multilayer.

39. The surface of claim 38, wherein the plurality of nanometer-scale features includes a nanoparticle between 1 nanometer and 100 nanometers in size.

40. The surface of claim 38, wherein the plurality of nanometer-scale features includes a silica nanoparticle, a silver nanoparticle, a gold nanoparticle, or a polystyrene nanoparticle.

41. The surface of claim 33, wherein the surface has a water contact angle of less than 5°.

42. A surface comprising a polyelectrolyte multilayer arranged on a substrate, wherein the surface includes a superhydrophobic region and a superhydrophilic region.

43. The surface of claim 42, wherein the superhydrophobic region or the superhydrophilic region forms a pattern on the surface.

44. A method of making a superhydrophobic surface comprising coating a superhydrophilic surface with a hydrophobic material.

45. A method of altering the wettability of a surface comprising:
providing a substrate having a surface coated with a coating including a polyelectrolyte;
contacting the coating including the polyelectrolyte with a roughness-inducing medium to form increase the roughness of the coating; and
introducing a plurality of nanometer-scale features to the coating to form a composite coating.

46. The method of claim 45, further comprising forming a hydrophobic coating over the composite layer.

47. The method of claim 45, wherein introducing a plurality of nanometer-scale features includes contacting the coating with a plurality of nanoparticles.

48. The method of claim 45, wherein providing a substrate having a surface coated with a coating including a polyelectrolyte includes contacting the substrate with a polyelectrolyte.

49. The method of claim 48, wherein the polyelectrolyte is a component of an aqueous solution.

50. The method of claim 49, wherein the aqueous solution includes poly(allylamine hydrochloride).

51. The method of claim 49, wherein the aqueous solution includes poly(acrylic acid).

52. The method of claim 45, wherein the roughness-inducing medium is an aqueous medium.

53. The method of claim 45, wherein contacting the coating including the polyelectrolyte with a roughness-inducing medium includes forming a pore in the coating.

54. The method of claim 53, wherein contacting the coating including the polyelectrolyte with a roughness-inducing medium includes forming a pore between 0.2 micrometers and 20 micrometers in size in the coating

55. The method of claim 45, further comprising crosslinking the coating including the polyelectrolyte.

56. The method of claim 55, wherein crosslinking the coating includes heating the coating.

57. The method of claim 47, wherein the plurality of nanoparticles includes a nanoparticle between 1 nanometer and 100 nanometers in size.

58. The method of claim 47, wherein the plurality of nanoparticles includes a silica nanoparticle, a silver nanoparticle, a gold nanoparticle, or a polystyrene nanoparticle.

59. The method of claim 46, wherein forming a hydrophobic coating over the composite coating includes contacting the composite coating with a hydrophobic silane.

60. The method of claim 46, wherein forming a hydrophobic coating over the composite coating includes contacting the composite coating with a fluoropolymer.

61. The method of claim 45, wherein the substrate is glass.

62. The method of claim 45, wherein the substrate is plastic.
